(19) United States
(12) Patent Application Publication
(10) Pub. No.: US 2026/0300708 A1
(43) Pub. Date: Oct. 1, 2026

(54) Hybrid CPU GPU Execution Framework for Large Language Model Inference with Reinforcement Learning Enhanced Adaptive Computation Time

(71) Applicant: Sam Khoze, WEST HOLLYWOOD, CA (US)

(72) Inventor: Sam Khoze, WEST HOLLYWOOD, CA (US)

(21) Appl. No.: 19/095,553

(22) Filed: Mar. 31, 2025

(51) Int. Cl. G06N 3/063; G06N 3/0495; G06N 3/096

(52) U.S. Cl. CPC G06N 3/063; G06N 3/0495; G06N 3/096

(57) ABSTRACT

A hybrid CPU-GPU execution framework is disclosed for efficient large language model inference using a reinforcement learning (RL)-enhanced adaptive computation time mechanism. A large language model is fine-tuned with RL to learn when to halt further processing and output an answer, balancing accuracy and computation. This learned policy dynamically skips unnecessary neural network layers or tokens for easy inputs and engages more computation for hard inputs. The system deploys the model across heterogeneous hardware: it allocates heavy computations to GPUs (or other accelerators) and uses CPUs for lighter tasks, guided by the model's policy. The model is compressed (e.g. quantized to 8-bit) to boost CPU performance. The result is an inference system that delivers fast, reasoning-rich responses efficiently, and is scalable from cloud to edge devices by adaptively adjusting both computation depth and hardware usage per query.

### CROSS-REFERENCE TO RELATED APPLICATIONS

This application is a non-provisional utility application. No prior U.S. patent application is claimed for priority, and no federally sponsored research or development is associated with the invention described herein.

### FIELD OF THE INVENTION

The present invention relates generally to artificial intelligence and machine learning systems, and more particularly to methods and systems for efficient inference of large language models using heterogeneous computing resources (such as CPUs and GPUs). It involves techniques in reinforcement learning, dynamic neural network execution, and computer architecture that together enable large language models to run with adaptive computation time on combined CPU-GPU (and other accelerator) platforms.

### BACKGROUND OF THE INVENTION

Large Language Models (LLMs) have demonstrated remarkable capabilities in natural language processing tasks, but deploying these models in practice is often challenging due to their immense computational requirements. Traditionally, achieving reasonable inference speed for an LLM (especially those with billions of parameters) has required expensive hardware accelerators like Graphics Processing Units (GPUs) or specialized AI chips. GPU clusters can provide the necessary parallel throughput for deep neural network operations, but they are costly to acquire and operate. Conversely, running LLMs on general-purpose Central Processing Units (CPUs) without acceleration typically results in high latency and low throughput, because CPUs execute the many linear algebra operations of an LLM much more slowly than GPUs. Organizations without access to ample GPU resources therefore struggle to deploy advanced LLMs cost-effectively. There is a pressing need for techniques that make LLM inference more efficient on commonly available hardware, or through better utilization of a mix of hardware, without sacrificing the quality of model outputs.

Various approaches in the prior art have attempted to reduce the computation required for neural network inference or to better utilize available hardware:
Adaptive Computation and Early-Exit Mechanisms: One line of research allows a neural network to perform conditional computation so that not every input triggers the full model depth. For example, BranchyNet (2017) introduced a deep network architecture with multiple “exit” branches; easier inputs can be classified at an intermediate layer via a side-branch output, while only harder inputs propagate to the deeper layers. This early-exit concept saves computation on easy cases. In the context of sequence models and transformers, others have proposed layer-skipping or early-stopping strategies. For instance, Google's adaptive decoder early-exit system (known as Confident Adaptive Language Modeling (CALM), 2022) uses a confidence measure at each decoder layer to decide whether to skip the remaining layers for the current token. If the model is “confident enough” in its prediction at an intermediate layer, it stops computing further layers for that token, significantly accelerating text generation. These methods demonstrate the feasibility of adaptive computation time in principle, achieving speed-ups (e.g. CALM can substantially reduce latency by skipping decoder layers when possible) while maintaining output quality via calibrated confidence thresholds. However, existing early-exit techniques typically rely on fixed heuristics or confidence thresholds to make halting decisions. They do not use a learned policy that optimizes the speed-accuracy trade-off, and they generally still assume a homogeneous hardware setup (usually a GPU or TPU) for all computations.
Reinforcement Learning for Conditional Computation: It is known from prior work (e.g. Bengio et al. 2015) that reinforcement learning (RL) can train neural networks to conditionally execute subsets of their operations. By formulating the decision of whether to continue processing or halt (or whether to activate certain units) as an action, an RL agent can learn a policy that yields faster inference with minimal accuracy loss. This has been applied in simpler model settings to skip parts of computation dynamically. In the LLM domain, recent research by others has begun exploring early-exiting large transformers for inference acceleration, confirming that substantial computation (on the order of 30-50% of transformer layers) can be skipped for many inputs with only minor impact on output quality. These studies provide a foundation suggesting that an RL-driven halting policy for a language model is viable. Nonetheless, prior systems have not fully integrated such RL-based adaptive computation with the deployment architecture of the model; typically, they focus on reducing layer usage but not on how to best allocate the model's workload across different hardware resources.
Model Compression and Optimization: Another area of relevant prior art is model compression techniques aimed at making large models more efficient. Quantization is one widely used technique, wherein model weights (and sometimes activations) are converted from high precision (32-bit floating point) to lower precision representations (such as 8-bit or 4-bit integers). Previous work has shown that careful quantization can dramatically reduce memory footprint and increase inference speed (especially on CPU hardware that may have optimized integer arithmetic instructions), with only a small loss in accuracy. For example, 8-bit transformer inference techniques (e.g. the LLM.int8 approach) demonstrate that even very large models can be run with int8 weights. Knowledge distillation is another technique, where a large “teacher” model's knowledge is distilled into a smaller “student” model by training the smaller model to imitate the teacher's outputs; this can yield a model that is much faster and lighter, albeit at the cost of some capacity. While compression and distillation alone can make deployment easier, they do not address the dynamic usage of computation on a per-input basis. They are generally orthogonal improvements that can be combined with adaptive inference strategies.
Heterogeneous Computing and Scheduling for Inference: There have been attempts to utilize heterogeneous hardware to meet the demands of LLM inference. Some known systems partition neural network execution between different processor types to exploit their respective strengths. For example, TwinPilots (2023) is a framework that splits a transformer model's layers between a GPU and a CPU and runs them in tandem: certain layers (such as the first few) are pinned to always execute on the GPU, while later layers reside in CPU memory and execute on the CPU. This kind of static partitioning helps when the model is too large for GPU memory alone or when trying to use both CPU and GPU to increase throughput, but it does not adapt to input complexity; every input still goes through the same number of layers on each hardware, so easy and hard inputs get identical treatment. Other research projects have looked at scheduling and serving multiple inference requests efficiently in data center environments. For instance, systems like InferLine and similar schedulers attempt to allocate resources to incoming LLM queries in an optimal way (e.g., by predicting which queries will be slow and scheduling them appropriately to meet service-level objectives). We will refer to one such hypothetical system as “Scheinfer”, representing a class of scheduler-driven inference frameworks.

These typically treat the model as fixed and focus on queueing and allocating requests to hardware instances, rather than modifying the model's computation per request. They also don't teach an internal mechanism for the model itself to decide on-the-fly how much computation to use.

In summary, prior art provides partial solutions: BranchyNet and related early-exit networks show that adaptive layer usage can speed up inference, and Google's CALM specifically targets transformer models with a confidence-based halting approach; however, these rely on static criteria and do not leverage learning to make halting decisions. Reinforcement learning has been recognized as a way to train adaptive policies for neural networks, but has not been applied in a deployed large-scale LLM inference system combining hardware considerations. Techniques like quantization and distillation improve efficiency broadly but do not in themselves provide per-input adaptation. Finally, heterogeneous execution paradigms such as TwinPilots demonstrate running an LLM across CPU and GPU, yet they use a predetermined split rather than dynamic scheduling per input, and scheduler frameworks manage resources externally without altering the model's internal computation pattern. None of the known solutions integrates all these aspects—dynamic learned computation time, and intelligent hardware-aware scheduling—into a unified system. The present invention addresses this gap by providing a hybrid CPU-GPU execution framework for LLM inference that uses a reinforcement learning-trained policy to adaptively decide both how much computation to perform and on which hardware to perform it for each input, thereby achieving improved efficiency over the prior art while maintaining high answer quality.

### SUMMARY OF THE INVENTION

The invention is a Hybrid CPU-GPU Execution Framework for Large Language Model (LLM) Inference with Reinforcement Learning-Enhanced Adaptive Computation Time. In general, the framework enables an LLM to dynamically adjust its inference effort on a per-query basis and to intelligently utilize heterogeneous computing resources (including CPUs, GPUs, and potentially other accelerators) to maximize efficiency. The large language model is fine-tuned with a reinforcement learning approach so that it learns an adaptive computation policy (sometimes called a halting policy) which governs two key decisions during inference: (1) when to stop the reasoning process (i.e., stop generating further layers or tokens) once an output is good enough, and (2) whether to execute certain portions of the model's inference on a CPU or on a GPU based on the difficulty of the input and the workload characteristics. Through this policy, the model skips unnecessary computations for easier inputs and focuses resources where needed for harder inputs, and it allocates workloads to the most appropriate processor (e.g., heavy calculations to the GPU, lightweight tasks to the CPU) to balance speed and resource usage. This represents an improvement over static early-exit methods and fixed hardware partitioning in the prior art.

Key features and components of the invention include:
Reinforcement Learning-Enhanced Adaptive Computation Time (ACT): During a fine-tuning phase, the LLM is trained via reinforcement learning to develop a halting policy. A structured reward signal is used to encourage desirable behavior—for example, the policy gets positive reward for producing correct and useful answers and for doing so with fewer computation steps, while it may get a small penalty for each additional step taken to incentivize efficiency. This training may be accomplished using algorithms such as Proximal Policy Optimization (PPO) or other policy gradient methods, allowing the model to learn an optimal trade-off between computation and accuracy. Unlike heuristic early-exit criteria, this learned policy can flexibly incorporate various signals (confidence measures, intermediate results, etc.) to decide if further reasoning will likely change the answer or not. As a result, the model can “decide” on the fly to terminate early when appropriate, or continue reasoning deeper when needed, in a manner that is tuned to maximize an overall reward (which reflects answer quality and speed jointly).
Dynamic CPU-GPU Execution Scheduling: The invention introduces a runtime system that leverages the learned policy to dynamically schedule parts of the inference computation on either CPU or GPU. In one embodiment, the policy's action space is extended so that at certain decision points the model not only evaluates whether to halt or continue, but if continuing, it may also choose which hardware to use for the next segment of computation. For instance, the policy might decide after a few transformer layers that a particular query is complex and would benefit from acceleration, triggering the remaining layers to run on the GPU; conversely, for an easy query, the policy might keep the computation on the CPU or stop earlier. The runtime monitors the model's state (or uses the model's own internal signals) to route each portion of the inference to the appropriate processor. This means sending a batch of tokens or a set of transformer layers to the GPU for processing, then switching back to the CPU for finalization if needed. By adaptive hardware allocation, the system ensures that the powerful GPU is utilized primarily for the hardest computations or when batch processing yields gains, while the CPU handles simpler cases or background tasks—thereby avoiding GPU overuse on trivial tasks and saving GPU cycles for when they matter most. This behavior contrasts with systems like TwinPilots, which have a fixed assignment of layers to hardware. Here, the assignment is input-dependent and policy-driven, yielding more efficient use of heterogeneous resources across varying workloads.
Hybrid Deployment Architecture: The LLM, after RL fine-tuning, can be deployed on a computing platform that has both CPUs and GPUs available. The framework includes a deployment manager that orchestrates inference across these resources. In a single-server scenario, the deployment manager may run multiple instances or threads of the model on the CPU and GPU, and it uses the model's policy decisions to coordinate the workflow (e.g., when the model indicates to use the GPU, the manager directs data to the GPU instance). In a distributed or cloud cluster scenario, the invention can be scaled out: for example, some servers in a cluster might contain GPUs while others are CPU-only, and a centralized scheduler or load balancer can direct incoming queries to different nodes depending on their complexity or the current load. A complex query might be routed to a node with a GPU for faster processing, whereas a simple query is handled by a CPU-only node if sufficient, freeing up GPU resources for more demanding tasks. The framework thereby supports heterogeneous clusters of machines. This cluster deployment strategy ensures scalability and high throughput-multiple queries can be served in parallel across the cluster, and each query gets an execution plan (sequence of computations on CPU/GPU) tailored to its needs.
Model Compression (Quantization) and Optimization: To further improve efficiency, especially for the portions of the inference that run on CPUs (or other limited resource devices), the large language model can be quantized to use low-precision representations. In preferred embodiments, after the RL fine-tuning, the model's weight parameters are converted from 16 or 32-bit floats to 8-bit or even 4-bit integers. This reduces the memory footprint (important for memory-limited environments) and accelerates matrix multiplications on CPUs which often have fast integer arithmetic units. The system is designed to handle these low-precision calculations without appreciable loss of accuracy thanks to the robustness imparted by the fine-tuning process. The quantization can be applied to the entire model or selectively to parts of the model (e.g., only to certain layers or only to weights but not activations, depending on the desired trade-off). Additionally, the architecture takes into account CPU-specific optimizations: for example, it may utilize multi-threading and NUMA-aware memory placement when running on multi-core CPU servers to maximize throughput. By combining quantization with the adaptive execution, the invention essentially squeezes maximum efficiency out of the CPU side, allowing it to handle a larger share of the work where possible. In scenarios where an accelerator (GPU) is not available at all (e.g., on some edge devices), the quantization and the learned halting policy together allow the model to still run reasonably fast on CPUs alone—something that prior high-end LLMs could not do effectively.
Support for Diverse Hardware Environments: While we often refer to “CPU” and “GPU” for clarity, the framework is designed to be agnostic to the specific types of processors; it can work with any mix of a general-purpose processor and one or more specialized accelerators. This includes current and future hardware such as neural processing units (NPUs), AI accelerator ASICs (application-specific integrated circuits like Google's TPU or others), and system-on-chip (SoC) designs that integrate CPU and GPU cores on the same die with unified memory. The adaptive scheduler can incorporate such accelerators similarly to a GPU (executing model layers on the NPU, for example, when beneficial). In an embodiment targeting mobile or edge deployment, the computing platform might be a smartphone or an IoT device with an integrated GPU/NPU; the invention would allow the LLM to run on-device, using the phone's GPU for heavy tasks and CPU for light tasks, all under the control of the same learned policy. the policy can even be tuned to consider power usage—for instance, preferring fewer steps or greater CPU usage to save battery when possible. Thus, the invention covers a wide range of deployment scenarios from cloud servers to resource-constrained edge devices.
Knowledge Distillation for Model Size Reduction: As an additional embodiment, the invention includes a knowledge distillation process to produce a smaller version of the model that still retains the benefits of the adaptive computation policy. After training the full-sized model with RL (as described above), one can use it as a “teacher” to generate a large number of example question-answer pairs (including the model's chain-of-thought if applicable). A smaller “student” model is then trained on this data to mimic the teacher's behavior (including, potentially, the halting decisions). The student model, which is a fraction of the size (e.g., about one-fifth the number of parameters), can also be fine-tuned with a similar RL objective or directly supervised using the teacher's outputs. This results in a compact model that is more feasible to deploy on very low-power hardware (or simply to achieve higher speeds), while still performing adaptive reasoning and early stopping in a manner qualitatively similar to the larger model. This distilled model too can be quantized. Having such an option broadens the range of use-cases for the invention: For example, an enterprise deploys the large model on servers for the highest-accuracy responses, but uses a smaller distilled model on a mobile app for quick on-device answers. Both operate under the same overall framework of adaptive, RL-guided inference.

Overall, the hybrid CPU-GPU execution framework described in this invention provides a comprehensive solution for efficient LLM inference. By combining reinforcement learning-driven adaptive computation with heterogeneous hardware scheduling, along with model compression and scalable deployment strategies, the system achieves improved inference efficiency compared to prior art. In practical terms, an LLM deployed with this invention can achieve higher throughput and lower latency than a conventional deployment while using far fewer expensive accelerator resources, and can even match or exceed the performance of some exclusively GPU-based solutions. This means that organizations can deploy advanced reasoning-capable LLMs at lower cost, leveraging existing CPU infrastructure and a limited number of GPUs in smart ways. The invention thus enables large-scale, cost-effective use of LLMs in production environments—from cloud data centers to edge devices—without sacrificing the quality of the model's outputs. It distinctly departs from known systems like BranchyNet or CALM by using a learned policy rather than fixed thresholds, and from systems like TwinPilots by introducing per-input dynamic hardware allocation rather than a one-size-fits-all partition. The result is a more flexible and efficient inference framework.

### BRIEF DESCRIPTION OF THE DRAWINGS

FIG. 1 is a schematic diagram of the reinforcement learning training architecture for the large language model's adaptive computation policy. In the illustrated training loop, an input query (101) is provided to a large language model (LLM) policy model (102), which generates one or more intermediate reasoning steps (103) and ultimately a final answer (104) for that query. A reward model (105) evaluates the correctness of the final answer and the quality of the reasoning process (e.g., coherence and clarity of the chain-of-thought) and produces a reward signal. An RL trainer (106) (for example, a PPO-based trainer) uses this feedback to update the LLM's parameters, fine-tuning the model's policy and yielding an updated LLM (107). The closed-loop diagram in FIG. 1 illustrates how the model learns to decide when to halt further reasoning and output the answer versus when to continue reasoning, guided by rewards for accuracy and efficiency.

FIG. 2 is an example deployment architecture of the LLM system on a computing cluster according to the present invention. In this illustration, two server nodes (203) and (204), shown as grey boxes, each host an instance of the quantized LLM model. A load balancer (202) (red box) receives an incoming user query (201) and distributes it to one of the LLM instances on the server nodes. The servers process the query and return a user response (206). The two servers are connected via a network, enabling them to share the load of multiple queries. This figure demonstrates a scalable setup in which multiple CPU-based servers (and, in an extension, servers with GPUs) can serve LLM queries in parallel. Although FIG. 2 depicts a CPU-only cluster for simplicity, in a hybrid CPU-GPU deployment each server may also contain a GPU or other accelerator. The load balancer or a scheduling system can route queries to different nodes or decide which device to use on each node in accordance with the model's policy. This distributed architecture (205) enables the system to handle a high volume of requests and to make efficient use of available hardware resources while providing fast, reasoning-enhanced answers.

### DETAILED DESCRIPTION OF THE INVENTION

Embodiments of the present invention will now be described in detail, with reference to the drawings where appropriate, to illustrate the structure and operation of the hybrid CPU-GPU LLM inference framework. It should be understood that these embodiments are examples provided to enable those skilled in the art to practice the invention, and numerous variations and modifications are possible within the scope of the inventive concepts.

System Overview: The core of the system is a large language model (102) configured for adaptive inference. Initially, this model is a standard pre-trained LLM (for example, GPT-3, T5, or another transformer-based text generation model), which is then augmented through a special fine-tuning procedure so that it gains a form of control logic for its own computation. This control logic—essentially a learned halting or continuation policy—is not hard-coded, but rather learned through reinforcement learning. Once fine-tuned, the model contains additional mechanisms that dictate, at runtime, whether to continue processing further tokens/layers and which compute unit (CPU or GPU) to utilize next. The model can be viewed as having two intertwined parts: (1) the primary neural network that produces the content (e.g., next-token predictions), and (2) a policy mechanism that monitors the inference process and makes meta-decisions about that process.

In some implementations, these could be separate modules (for example, a policy network that observes the state of the main network), or they could be integrated (for example, extra outputs from certain layers indicating confidence or recommending halting). The important aspect is that the model can dynamically adjust the depth of computation and choose the execution venue (CPU or GPU) on the fly.

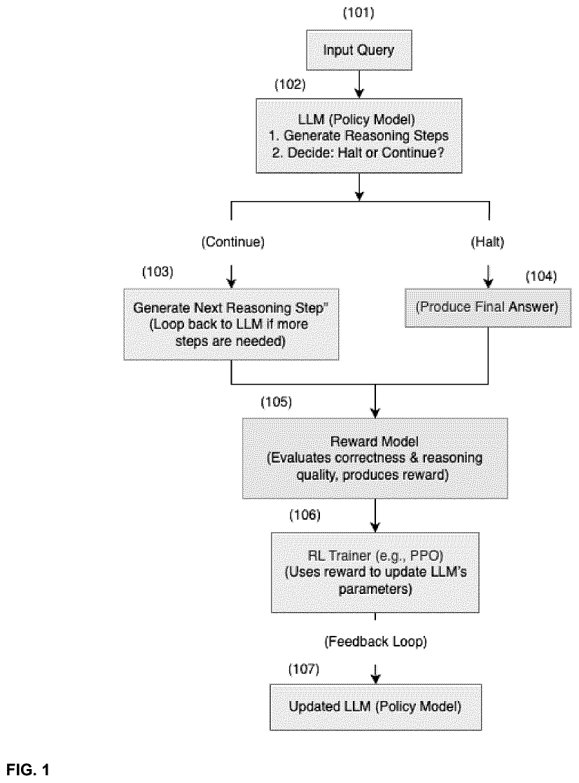

The hardware environment is assumed to be heterogeneous. At minimum it includes one general-purpose processor (CPU) and one accelerator (GPU or equivalent). For clarity, the scenario will be described with one CPU and one GPU, but extensions to multiple CPUs or GPUs are straightforward. The CPU and GPU are connected by a high-speed bus (e.g., PCIe) and they either share main memory (in an integrated system) or have separate memory spaces (in a discrete GPU with its own VRAM). The software components include the LLM code (the policy model (102) shown in FIG. 1, capable of running on either CPU or GPU), a scheduler/controller that is part of the runtime and decides how to route computation, and standard inference-serving infrastructure (which handles receiving queries, managing batches if applicable, and returning responses). Optionally, a separate reward model (105) and RL trainer (106) are used offline (not during deployment) to train the LLM during development; these components are utilized in the training phase and are not needed during inference serving.

Reinforcement Learning Fine-Tuning Phase: After the base LLM is pre-trained on general text (to learn basic language modeling), a reinforcement learning fine-tuning phase is conducted to encourage better reasoning and efficiency. A common algorithm for this fine-tuning is Proximal Policy Optimization (PPO), a stable and effective policy-gradient method. In this setup, the LLM itself is treated as the “policy” to be optimized. The model's action at each step of generation is defined as whether to continue generating more content or to halt and output the current result. In practice, this can be implemented by adding a special halting token or by using an internal binary indicator at each step that the model learns to set. Additionally, the action space can be extended to include a decision such as “proceed on CPU” vs. “proceed on GPU” for the next chunk of computation—effectively making the hardware choice a part of the action. Including hardware decisions directly in the learning loop can be tricky to simulate; an alternative approach is to train the halting policy with RL (assuming a single device for simplicity during training), and then separately incorporate a heuristic or lightweight classifier that predicts when a given input should use the GPU. Another integrated approach is to incorporate a cost in the reward that reflects using the GPU (for example, a small penalty whenever GPU usage is invoked, to encourage frugality unless necessary), so that the policy implicitly learns to invoke the GPU only when the additional speed is worth that cost. For clarity of exposition, we primarily focus the RL training on the halting decision (i.e. how many steps to run), with the hardware scheduling policy derived from the model's confidence or state (potentially with learned thresholds). Both approaches are within the scope of the invention: an end-to-end RL policy that jointly learns when to use the GPU, or a two-step decision process (one learned, one rule-based) that achieves a similar outcome.

During RL training, we generate queries for the model (these could be actual user questions or prompts representative of the deployment scenario). For each query (101), the LLM (102) produces a series of intermediate reasoning steps (103) (if we have designed it to output a “chain-of-thought”) and a final answer (104). A reward model 105 (which could be a separately trained neural network or a programmatic evaluation function) then scores the model's output. The reward typically has multiple components: for instance, +1 for a correct final answer, +0.2 for each intermediate reasoning step that is deemed logical or helpful, and a small negative reward (penalty) for each step taken to discourage unnecessarily long reasoning. In one embodiment, the total reward for a given query might be calculated as a weighted sum of such factors

$$R = {R}_{answer} + α \cdot {R}_{reasoning} - β \cdot {N}_{steps}$$

where R_{answer} is a reward (e.g., 1 or 0) for the correctness of the final answer, R_{reasoning} is a reward for the quality of the reasoning process (scaled by a factor α), and Nₛₜₑₚₛ is the number of reasoning steps or the inference time (with β being a small penalty per step or per unit time). The terms a and 3 balance the importance of good reasoning versus speed; by adjusting these, an operator can make the model more or less inclined to spend extra time thinking. This reward signal is fed into the PPO trainer (106), which then updates the LLM's parameters to maximize expected reward, thereby fine-tuning the model's policy (resulting in an updated LLM (107)). Over many training iterations, the model learns to produce better reasoning chains that lead to correct answers (thanks to the R_{answer} and R_{reasoning} feedback) and learns to cut off its reasoning when it becomes redundant (thanks to the penalty for length). The result of this training is a policy embedded in the LLM that essentially can decide: “Have I likely arrived at a sufficiently good answer? If yes, stop now; if not, continue thinking.” This mechanism is the Adaptive Computation Time (ACT) at work, enhanced by RL to be context-sensitive rather than using a fixed threshold. Notably, the policy might learn to use fewer steps on easier questions (because continuing doesn't increase reward much if it already has a correct answer) and to use more steps on harder questions (where extra reasoning could improve the answer and thus yield a higher reward).

If hardware decisions are also being learned, the training environment must simulate the effect of using GPU vs CPU. One could incorporate an approximate time cost into the reward (e.g., penalize the model for using CPU step vs GPU step differently if desired). However, a simpler approach we might use is: first train the halting policy purely for deciding how many steps yield the best trade-off (on a single device), and separately analyze the model's behavior to devise a scheduling strategy. For example, after RL training, we could observe that the model tends to use X steps for certain types of inputs. We can then set a rule that if the model is likely to use more than a certain number of steps (i.e., the input seems complex), we execute those steps on the GPU, whereas if it will stop early anyway, we just use the CPU. This rule can be implemented as a small classifier that looks at the input or initial transformer activations to predict complexity. In an alternative embodiment, we explicitly train the model with an action “use GPU now”, by running some trials where using the GPU results in a lower notional time cost. The model could then learn, for example, to output an action that switches hardware when it's dealing with a long or complex sentence (because it has learned that doing so yields a better overall reward due to faster completion).

Inference Phase with Adaptive Scheduling: Once training is complete, we have a large language model that knows how to decide when to stop. We integrate this model into a serving system that can exploit both CPU and GPU. The inference process for a single query works as follows in one embodiment:
1. A user query is received by the system. (The query might be a question or prompt that the LLM needs to respond to with a generated answer or continuation.) Optionally, the query is first processed by some lightweight pre-processing on the CPU (for example, tokenization or formatting). Then the inference manager (which could be part of the deployment manager) decides how to initialize the model computation. For instance, the first few layers of the transformer might be set to run on the CPU by default. (In other embodiments, one might always start on the GPU; the strategy can vary. Here we assume an initial execution on CPU to avoid incurring GPU cost unless needed.)
2. The model begins generating the answer token by token. It runs forward passes through its neural network to predict each next token. After each token (or after a certain block of layers), the model's internal policy mechanism evaluates whether to continue or not. This could be implemented by checking the output probability for a special “halt” token, or by evaluating a small network that takes the current hidden state and outputs a binary decision. If the decision is to halt, the model stops and the current output is taken as the final answer. If the decision is to continue, the model proceeds to compute the next token.
3. Crucially, when the model decides to continue, the system also decides where to execute the next part of the computation. If the model has only used a small number of steps so far and everything is running quickly on the CPU, it may remain on the CPU. But if the model has been iterating many times (indicating a complex query), at some point it may trigger a switch to GPU to speed up the remaining computation. The switch can be decided by a predetermined threshold (e.g., if more than N tokens have been generated without halting, then use GPU for subsequent processing), or by a learned criterion (the model could have a learned signal that indicates “this is getting complicated, offload to GPU”). In practice, implementing a seamless switch means that the model's state (the activations or context so far) must be transferred to the GPU, and then the GPU will carry out further forward passes. Modern frameworks allow moving model layers or the whole model between devices at runtime, though with some overhead. An optimized implementation could keep both CPU and GPU copies of the model ready, and only move the minimal necessary data (like the current token embeddings) between devices. The overhead of switching devices is taken into account, so the system might only do it if the remaining work is significant enough to justify it.
4. Once on the GPU, the model continues generating tokens, now much faster per step due to the GPU's parallelism. The policy checks at each step if it should halt. Eventually, the model decides to halt (either on its own or after reaching a maximum length limit). At that point, if the GPU was used, the final output is already on the GPU memory and can be transferred back to CPU memory if needed for post-processing or delivering to the user.
5. The final answer is output. Optionally, the system might also output the reasoning path (if the model was generating an explicit chain-of-thought) or certain metadata, but typically it will just return the answer text.

Throughout this process, the adaptive policy ensures that if the query was easy, many unnecessary layers or tokens were skipped. For example, imagine a yes/no question that the model can answer confidently after just a brief internal computation—the policy might halt the model after generating a short sentence, rather than the model rambling on. In contrast, for an open-ended complex question, the model might generate a longer explanation or do multiple steps of reasoning (thus consuming more compute and possibly invoking the GPU to handle it efficiently).

The adaptive hardware usage is a standout aspect: if no GPU is present, the system gracefully continues on CPU for all steps (simply the policy won't have the option to switch, or the threshold is effectively infinity). If a GPU is present but the load is low, the system might still choose to keep easy tasks on CPU to avoid idle CPU and unnecessary GPU context switching. This ensures the GPU is used in a targeted way, somewhat analogous to how an operating system schedules tasks on a big core vs little core in heterogeneous CPU setups. The invention thus provides a form of intelligent load balancing between CPU and GPU at the level of neural network inference, guided by the model's own assessment of each query's difficulty.

Parallel and Pipelined Execution (Optional): In some embodiments, the system can further optimize throughput by running parts of the model in parallel on CPU and GPU. For example, the model's architecture could be split such that some layers are designated to always run on CPU and others on GPU, creating a pipeline: while the GPU is processing one batch of data (e.g., the attention layers), the CPU could be concurrently preparing the next batch or executing a different component (e.g., embedding lookup or output projection). This way, both CPU and GPU are active simultaneously, improving hardware utilization. One could also process multiple tokens in parallel in a speculative manner: for instance, the model might tentatively generate multiple candidate continuations and quickly eliminate those that seem unlikely (this is a bit beyond the core concept, but it's another approach to speed up autoregressive generation known as speculative decoding). The adaptive framework is compatible with these enhancements. Systems like TwinPilots hint at parallel CPU-GPU usage; our invention can encompass similar parallelization, but augmented with the adaptive policy (so it could dynamically adjust the pipeline depth or branch depending on input).

In a multi-query scenario (like a production server handling many users), the deployment manager can maintain separate model instances or contexts for different queries. It can leverage the adaptive policy to schedule queries intelligently: for example, if one query is known to require a lot of reasoning (maybe the model has already generated a lot for it), the manager might move that instance to a GPU thread, while allowing other shorter queries to be handled on CPU cores in parallel. This kind of scheduling can significantly increase overall throughput, as simpler tasks don't get queued behind complex ones—a form of dynamic service differentiation made possible by the model's own signals. Traditional systems might treat all queries equally or have to rely on external heuristics to predict which query is complex; here the model internally provides that signal via its halting mechanism (e.g., if it hasn't halted after X steps, that's an implicit indicator of complexity).

Quantization and Efficiency Considerations: After the RL training, the model is typically quantized. The weights of the neural network are converted to 8-bit integers, and in some cases, activations are also quantized to 8-bit during inference. This process can be done post-training (with calibration to minimize accuracy loss), or the RL fine-tuning can even be performed with quantization-aware techniques so that the model is already robust to low precision by the end of training. The quantized model uses considerably less memory—for instance, an LLM with 20 billion parameters at 16-bit would be ~40 GB, but at 8-bit it becomes ~20 GB, which might allow it to fit in CPU RAM and GPU memory simultaneously more easily. This reduction enables deployment on commodity hardware (where otherwise only a portion of the model might fit on a single GPU). Additionally, many CPUs have specialized instructions (like AVX512 or AMX on modern x86 servers, or NEON on ARM) to accelerate integer math, meaning the quantized model can run faster on CPUs. In practice, we observe that quantization, combined with the adaptive skipping of layers/tokens, allows CPU inference to be practically useful—something that would be prohibitively slow if the full model had to run at full precision for every query. The invention leverages this by often handling the beginning of inference on CPU; thanks to quantization and possibly batching of multiple CPU threads, the initial computation is not too slow. If needed, the GPU is then engaged for the remainder.

It's worth noting that the GPU could use a different precision than the CPU. For example, the GPU might run the model in half-precision (FP16) which is standard for accelerators, while the CPU uses int8. This is an acceptable variation. The system ensures that the minor numerical differences from using different precisions on different hardware do not affect the overall functionality of the model's policy. The RL training typically instills a degree of tolerance (and if concerned, one could train with some noise or quantization simulation to make the model robust to such changes).

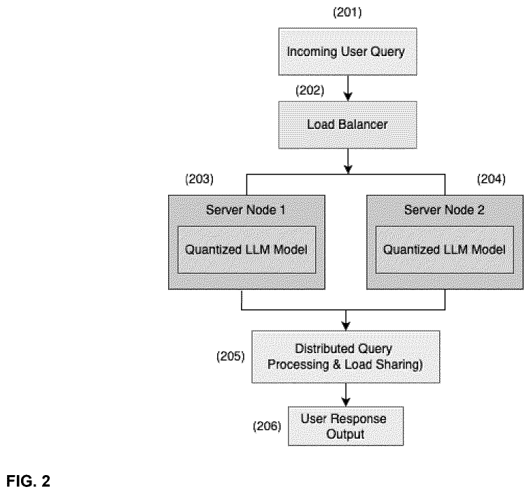

Deployment Manager and Infrastructure: The deployment manager is the software service that keeps the model running and accessible. In a simple setup, it loads the model weights (perhaps in both CPU and GPU memory), spawns worker threads or processes, and listens for incoming requests. Each request is then handled as described above (possibly using a task queue if many requests arrive). In a cluster setup, as depicted in FIG. 2, multiple instances of this service may run on different machines (for example, on server node (203) and server node (204)). These instances can share the processing of incoming queries (distributed query processing and load sharing (205)). A central orchestrator or load balancer (202) distributes incoming user queries (201) among the machines. The invention contemplates that some machines might have GPUs and some might not. The load balancer can tag each query or route it based on the current load and an estimate of complexity (for example, the number of tokens or certain keywords in the query might hint at complexity). Alternatively, the system could adopt a two-stage approach: first send every query to a CPU-only instance for the first few steps of reasoning; if that instance finds the query is simple and halts quickly, it finishes and returns the answer (206) to the user. If not, it can either itself invoke a GPU (if it has one locally) or hand off the partially processed query to a GPU-enabled server to finish the job. This kind of hand-off would involve serializing the model's current state and migrating it—which is complex but within scope for advanced implementations. In many cases, however, simpler routing (such as directing long queries or certain tasks to GPU-equipped servers from the start) will suffice.

Mobile and Edge Deployment: In an embodiment meant for mobile devices (e.g., a smartphone app running an LLM assistant), the system would run on a single SoC that includes multi-core CPUs, a mobile GPU, and perhaps a dedicated NPU (as found in modern phones for AI tasks). The model, likely a smaller distilled version, would be quantized (possibly to 4-bit to fit memory constraints). The halting policy would ensure that the model doesn't waste time or battery by over-processing easy inputs. For instance, if the user asks a straightforward question, the model might answer after a brief computation entirely on the CPU cores without even powering up the GPU (saving energy). If the user asks a very complex question, the device could activate the NPU/GPU to accelerate the model's reasoning, but only for as long as needed. The result is a responsive on-device AI that is conscious of the limited resources. This is a stark improvement over trying to run a large LLM on a phone at full depth for every query, which would be slow and drain the battery quickly. The invention's adaptability thus extends AI capabilities to edge scenarios that previously would require cloud offloading.

Future Accelerators and Integration: The design of the framework is forward-compatible with new hardware. For example, if a new type of AI accelerator emerges, one can integrate it by treating it similarly to the GPU in our descriptions. The scheduling policy can be updated to consider the accelerator as another option. In some cases, future accelerators might be so fast that the best strategy is always to use them; in that case, the policy might default to using the accelerator for most inputs but still retain the ability to cut computation short when possible. On the other hand, if an accelerator has a high setup cost but shines for large workloads, the policy might learn to only invoke it when a lot of computation remains. Because the policy is learned, if we were to retrain the model in an environment with different relative speeds (CPU vs accelerator), it could adjust its behavior. This ability to learn the optimal use of hardware is a powerful aspect of the invention: rather than the system designer having to manually tune thresholds for when to use the GPU, the model can be trained or meta-trained to make that decision in a reward-optimized way.

To illustrate concrete performance benefits (in a non-limiting example), consider an LLM that normally uses 100 transformer blocks to answer any question. Using our invention, it might learn to use on average only 50 blocks for a typical query, skipping the rest, and only going up to 100 for very hard cases. That alone is a 50% reduction in computation on average. Now, suppose that out of those 50 blocks it uses on average, perhaps 30 can be handled on CPU quickly (especially in 8-bit math), and the remaining 20 it offloads to GPU. The GPU, being an order of magnitude faster per operation, accelerates those 20 blocks such that their contribution to latency is small. Overall, the latency might drop to, say, ⅕th of the original (a combination of doing less work and doing part of the work faster). Through experiments and benchmarking (e.g., using standard LLM inference benchmarks), one would find significant improvements in throughput (queries per second handled) and in cost-per-query (since CPU time is cheaper than GPU time). The exact numbers depend on the model and hardware, but the pattern holds: the adaptive hybrid approach outperforms a naive GPU-only or CPU-only deployment for a wide range of queries.

Distinctiveness Over Prior Art: It is useful to explicitly contrast this invention with the earlier systems mentioned. Unlike Google's CALM, which applies fixed confidence thresholds to skip transformer layers, our system employs a learned policy via RL that can take into account more complex considerations than confidence alone (including semantics of the query, resource availability, etc.), and we extend the concept beyond just skipping layers to also deciding where to compute. CALM's early exit happens within the decoder of an encoder-decoder model and still assumes a single type of processor; our invention can early-exit at multiple points and can even decide to shift computation across device boundaries. Compared to BranchyNet and similar early-exit networks in vision, our invention deals with sequential text generation which requires a different approach (deciding per token rather than one-shot per input), and we specifically integrate the approach with large language models and their transformer architecture. BranchyNet also did not consider heterogeneous hardware at all. Relative to the TwinPilots approach (GPU-CPU parallel inference), our invention is more dynamic: TwinPilots uses a predetermined division of layers between GPU and CPU to address memory limits, whereas we allow each input to effectively have a custom division (some might run mostly on GPU, some mostly on CPU) based on the learned policy outcomes, which is a flexibility TwinPilots lacks. Furthermore, our policy can even decide to forego executing later layers entirely (which TwinPilots would never do, since it still runs the full model). When looking at systems focusing on scheduling, like the hypothetical Schelnfer, those treat the model as a black box and try to optimize throughput by scheduling requests to devices, often via heuristics or analytic models. In contrast, our invention opens the model's box and gives it agency in the process, yielding a synergy between the model's internal decision-making and the external scheduler. Essentially, the model's own behavior simplifies the scheduling problem (the model often short-circuits easier tasks quickly), and our runtime only needs to manage the cross-device execution as guided by the model's signals. This tight integration is novel and yields performance characteristics that purely external scheduling or purely internal adaptation cannot achieve alone.

### Alternative Embodiments and Extensions

In some embodiments, the reinforcement learning algorithm used could be something other than PPO. For example, a Deep Q-Network (DQN) approach could be used where the “state” is the model's current hidden representation and the action is whether to halt or continue. The Q-learning algorithm would learn the expected reward (Q-value) of continuing vs halting, and the policy would choose to halt when the Q-value of halting exceeds that of continuing. This might require discretizing some aspects of the state, but it is conceivable. Another approach could use actor-critic methods or even evolutionary strategies to evolve a halting policy. The invention is not limited to how the policy is learned—any reinforcement or even supervised signal that results in a usable halting mechanism is within scope. For instance, one could use human feedback to directly fine-tune the halting behavior (e.g., instructing the model that it should explain more in certain cases).
The scheduling between CPU and GPU could be governed by an external module that monitors real-time metrics like CPU load, GPU queue length, and other measurements. For example, if the GPU is currently busy serving another request, the scheduler might temporarily keep a new request on CPU to avoid waiting, even if normally it would offload it. This kind of real-time load-aware decision can complement the model's policy. The invention's claims encompass an approach where such a scheduler works in concert with the model's decisions to maximize overall system efficiency (this could be seen as a hierarchical decision system: model decides “need more computation” vs “I'm done,” and external scheduler decides “do it on GPU now” vs “CPU is fine given current conditions”).
The model's adaptive behavior might also include self-evaluation. For instance, after generating an answer, the model might internally verify or simulate the answer's correctness (using another pass or a different model) and decide to continue if it finds a flaw. This is like a reflection mechanism. If integrated, the policy isn't just “blindly” halting; it's halting after ensuring the answer likely meets a quality bar. This could further improve the reliability of early exits (making sure we don't stop too soon when the answer is wrong). All these enhancements can be built on top of the core idea of adaptive computation with RL.
The knowledge distillation option can be extended such that the smaller student model also inherits the halting policy. One way is to have the student model mimic not just the final answers of the teacher but also the teacher's halting decisions on various inputs. For example, if the teacher typically stops after 5 steps on input A, the student should learn to do the same (if it can). This may involve giving the student model the same reward structure or explicitly training it with supervised signals that indicate the desired number of steps for each example. The benefit is a smaller model that acts in an adaptively efficient way, suitable for deployment where even the quantized large model is impractical.
Use Case Scenarios: To ground the discussion, consider a few concrete use cases: Enterprise Q&A: A company deploys an internal LLM to answer employees' questions based on a knowledge base. Some questions are simple fact lookups, others require complex reasoning across multiple documents. Using the invention, the LLM will answer simple questions very fast (maybe in a second, on CPU only) by quickly producing an answer and halting. For more complex questions, it might take a few seconds and utilize a GPU to gather information and reason through it. The system automatically balances accuracy and speed, and because it doesn't always use the GPU, the single GPU can handle many users (since many queries bypass it). This reduces cost while ensuring hard questions still get the necessary compute.

Mobile Personal Assistant: On a smartphone, a personal assistant AI can run a distilled version of the LLM. When asked “What's the weather tomorrow?”, it only does minimal reasoning (the answer is straightforward, maybe just plugging into an API) and it might not need the on-chip NPU at all. When asked a more involved question like “Help me plan a weekend trip to the mountains with my kids,” the AI might engage the NPU to evaluate various options and provide a detailed plan, because it recognizes the complexity. The user experiences quick answers for easy questions and still gets thorough answers for hard ones, all computed on-device without always relying on cloud servers. Battery impact is minimized by the assistant's adaptive approach. Cloud API Service: A cloud provider offers an LLM inference API. Behind the scenes, they use our hybrid framework to serve requests. They notice that about 70% of queries to the API can be handled with very low compute (the model often stops early for those), so the GPUs in their server farm are mostly dedicating cycles to the remaining 30% of queries. This means they can serve many more requests per GPU than if every query consumed a full forward pass of the model. They might even allow a free tier of usage where most queries only hit CPU, reserving GPUs for premium users or particularly tough questions. The adaptive system makes such tiered operation seamless, since the model naturally does less work (and can be configured to use only CPU) on easy tasks.

In concluding this detailed description, we emphasize that the inventive framework provides a unified solution that covers methods, systems, and computer-readable media implementing the described adaptive LLM inference. The independent claims that follow define the scope of the invention, and the dependent claims specify particular embodiments and variations. Features from various embodiments may be combined as needed, and the terminology “CPU” and “GPU” is used broadly to denote classes of computing resources (general-purpose vs specialized parallel processor) and is not intended to exclude other forms of processors. The invention's scope is to be determined by the claims, and is not limited to the specific examples given here.

1. A computer-implemented method for efficiently executing inference of a large language model on a heterogeneous computing system comprising at least one general-purpose central processing unit (CPU) and at least one graphics processing unit (GPU), the method comprising:
(a) fine-tuning a large language model using reinforcement learning with an adaptive computation time mechanism, including training the model to learn a halting policy that determines, for each input or generation step, whether to continue an intermediate reasoning process or to terminate and output a final result, wherein the model is rewarded during training for producing correct and well-reasoned answers with fewer computational steps;
(b) quantizing the fine-tuned large language model to a lower-precision numerical format by converting the model's parameters from floating-point representation to an integer or reduced-bit-width representation, to reduce memory usage and enable faster arithmetic operations on the CPU; and
(c) deploying the quantized large language model on the heterogeneous CPU-GPU computing system by instantiating one or more runtime instances of the model and handling incoming user queries through these instances, wherein during inference for a given query the learned halting policy adaptively allocates computation between the CPU and the GPU, causing the model to skip processing steps deemed unnecessary for that query and to execute at least a portion of the required neural network computations on the GPU when the query's complexity or workload exceeds a predetermined threshold, whereby a reasoning-augmented response is produced with reduced overall computation time.

2. The method of claim 1, wherein the reinforcement learning fine-tuning is performed using a Proximal Policy Optimization (PPO) algorithm, and wherein the structured reward signal for the halting policy comprises at least a first component incentivizing accuracy of the final answer and a second component incentivizing clarity or coherence of the model's intermediate reasoning, such that the model learns to both improve answer quality and maintain a well-structured reasoning process.

3. The method of claim 1, wherein the reinforcement learning fine-tuning is performed using a value-based or policy-gradient reinforcement learning algorithm other than PPO to train the halting policy.

4. The method of claim 1, wherein the adaptive computation time mechanism learned by the model is implemented as a halting policy that, for each generated token or for each layer of the model during inference, evaluates a condition or confidence metric and decides whether to continue generating additional tokens or layers or to stop and output the current result, based on a learned threshold or internal state, such that the model uses fewer computation steps for simpler inputs and more steps for complex inputs, dynamically adjusting its depth of processing for each input.

5. The method of claim 1, wherein the learned halting policy or an associated scheduling rule further determines, at one or more intermediate points during inference, whether subsequent neural network computations for the current query should be executed on the CPU or on the GPU, based on the model's assessed difficulty of the query or the state of the inference (including the number of steps already taken), such that computationally intensive portions of the inference are offloaded to the GPU for speed while portions that can be handled with minimal latency or that are nearly complete are kept on the CPU, to optimize hardware usage for each query.

6. The method of claim 1, further comprising training a reward model or evaluation module during the fine-tuning phase to assess outputs of the large language model, wherein the reward model assigns a numerical reward score to an output sequence by evaluating both the correctness of the final answer and the quality of any intermediate reasoning or explanatory content produced by the large language model; and wherein the numerical reward score is used as the reinforcement learning reward signal to guide fine-tuning of the large language model's policy.

7. The method of claim 1, wherein quantizing the model comprises converting the model's weight parameters from a floating-point representation to 8-bit integer precision and converting at least a subset of the model's activation values to 8-bit or 4-bit precision, such that the model's memory footprint is reduced and the model's matrix multiplication operations can be executed using low-precision integer arithmetic on the CPU and on any compatible accelerators.

8. The method of claim 1, further comprising performing knowledge distillation from the fine-tuned large language model into a smaller student model, wherein the fine-tuned model is used to generate training examples (including intermediate reasoning traces if available) and the smaller student model is trained on these examples to replicate the output behavior of the fine-tuned model, resulting in a compact model that preserves the reasoning capabilities and adaptive halting behavior of the original model; and wherein the compact student model is subsequently quantized and deployed on the heterogeneous CPU-GPU computing system or on a CPU-only hardware platform as an efficiency optimization for environments where the full model is too resource-intensive.

9. The method of claim 1, wherein deploying the model on the CPU-GPU computing system includes running multiple instances of the model on a multi-core CPU or multi-socket server, each instance being affinitized to a specific subset of CPU cores and, if applicable, a local NUMA memory node, and configuring the inference execution such that each instance primarily accesses data from its local memory region, which improves throughput and consistency of latency on the CPU by reducing memory access contention and ensuring memory locality for each model instance.

10. The method of claim 1, wherein deploying the model further includes providing a load balancing or scheduling mechanism to distribute incoming inference requests across a cluster of computing nodes, the cluster comprising at least one node equipped with a GPU and at least one node that is CPU-only or has different hardware resources, and wherein the mechanism routes each query to an appropriate node or dynamically partitions the inference workload of each query among nodes based on the query's complexity and the available resources, such that computationally heavy queries are handled on GPU-equipped nodes and simpler queries on CPU-only nodes, ensuring efficient utilization of the heterogeneous cluster while maintaining low latency for each query.

11. The method of claim 1, wherein the structured reward signal used during reinforcement learning fine-tuning includes a penalty term that increases with the number of reasoning steps taken or with the length of the generated explanation, so that the large language model is incentivized to avoid unnecessary computation and to halt when further reasoning would not significantly improve answer accuracy.

12. The method of claim 1, wherein the computing system on which the model is deployed is a mobile or edge device featuring a system-on-chip that integrates the CPU and GPU and optionally a neural processing unit (NPU), and wherein the method further comprises optimizing the inference execution for the device's power and memory constraints by limiting GPU activation to only those instances when the model's policy deems it necessary for a complex query, and otherwise utilizing the CPU for lightweight inference, such that the large language model can run on the device within a fixed energy budget while still providing adaptively accelerated responses.

13. The method of claim 1, wherein the heterogeneous computing system further comprises at least one specialized AI accelerator selected from the group consisting of a neural processing unit (NPU), a tensor processing unit (TPU), and another machine-learning ASIC, and wherein the deploying step includes utilizing said accelerator to perform a portion of the model's inference computations such that the adaptive scheduling policy accounts for the presence of the accelerator and assigns computations to it when beneficial, analogously to how a GPU is utilized in the model's execution.

14. The method of claim 1, wherein during inference the large language model is executed in a pipelined or parallel manner on the CPU and GPU, such that different parts of the model's computation occur concurrently on both processors, resulting in reduced overall latency and increased utilization of both.

15. A large language model system for generating responses to user queries with high efficiency on a computing platform that includes heterogeneous processors, the system comprising:
at least one CPU and at least one GPU operatively coupled within the computing platform, the CPU and GPU providing computational resources for model execution;
a memory storing a large language model configured to generate a sequence of output tokens in response to an input sequence, the large language model having been fine-tuned via reinforcement learning to incorporate an adaptive reasoning and halting policy that dynamically adjusts the amount of computation performed for different inputs;
a scheduling controller configured to apply the adaptive reasoning policy during runtime inference by monitoring the large language model's progress on a given input and deciding whether to halt generation or continue and, if continuing, orchestrating whether the subsequent inference computations are carried out on the CPU or on the GPU, such that the controller directs the model to utilize the GPU for compute-intensive operations and to use the CPU for less intensive operations or when nearing completion of the query, in accordance with the policy's determinations;
a quantized parameter storage holding the weight parameters of the large language model in a low-precision numeric format that reduces memory bandwidth usage and computation requirements for executing the model on the CPU and GPU.
a deployment manager that manages one or more instances of the large language model across the CPU and GPU, routes input queries to the model instances, and oversees the transfer of data between the CPU and GPU as needed during inference;
wherein the large language model system is operable to produce reasoning-enhanced answers to input queries with reduced computation compared to a system that uses a fixed amount of computation for every query, and leverages both the CPU and GPU resources to provide fast response times while minimizing hardware usage by avoiding execution of the entire model on the GPU for each query, such that the large language model can be deployed in environments with limited or costly GPU resources.

16. The system of claim 15, wherein the at least one GPU is replaced or supplemented by at least one specialized neural network accelerator selected from the group consisting of an integrated neural processing unit (NPU) and a machine-learning ASIC, and wherein the scheduling controller is configured to utilize the specialized accelerator to perform inference computations such that the system is adaptable to different accelerator hardware for accelerated inference.

17. The system of claim 15, wherein the CPU and GPU are integrated on a single system-on-chip (SoC) within a mobile or edge computing device, and wherein the system is configured to run the large language model on the SoC under constrained resource conditions by ensuring memory usage stays within on-chip limits and by favoring the CPU or a low-power neural processing unit (N P U) for small workloads to conserve power while invoking the GPU cores only for demanding portions of inference, enabling on-device inference with adaptive speed and energy efficiency suitable for mobile deployments.

18. The system of claim 15, wherein the deployment manager is further configured to operate the large language model across a distributed cluster of computing nodes connected via a network, the cluster including a plurality of nodes with heterogeneous hardware capabilities, and wherein the system includes a load balancer or cluster scheduler that cooperates with the scheduling controller such that entire user queries or segments of a query's processing are assigned to different nodes based on available hardware resources, with queries requiring extensive computation directed to GPU-equipped nodes and simpler queries processed on CPU-only nodes, which scales the adaptive inference paradigm to a multi-machine environment and maximizes cluster throughput while maintaining low latency for each query.

19. The system of claim 15, wherein the quantized parameter storage stores the model's weights in 8-bit integer form and the large language model includes hardware-specific kernels or routines optimized for low-precision computations on both the CPU and the GPU, and wherein the system further comprises a high-precision storage of the model's parameters for use in fine-tuning or fallback to higher precision if needed, such that the system performs inference in a quantized mode by default for efficiency but retains the ability to utilize higher-precision computations when required without changing the deployed architecture.

20. The system of claim 15, wherein the scheduling controller utilizes the large language model's adaptive policy to implement an early-exit mechanism such that for a subset of user queries the model generates an output after processing only a fraction of its total layers or tokens and the controller halts further processing, so that for these queries the deployment manager does not invoke the GPU and the inference is completed entirely on the CPU; and for other queries that require more processing, the controller continues the model's execution and offloads the remaining computation to the GPU if the query's complexity merits it, until the inference is complete; whereby the system balances the computational load by using the GPU only when necessary and otherwise relying on the CPU for straightforward inferences, under the guidance of the learned policy embedded in the model.

21. The system of claim 15, further comprising a reward evaluation module used during reinforcement learning fine-tuning of the large language model to provide feedback on the model's outputs, wherein the module is not active during deployment inference but remains part of the system's training configuration; and wherein the adaptive reasoning policy present in the deployed model results from the training involving this module.

22. The system of claim 15, wherein the large language model is a transformer-based neural network with a plurality of layers, and the adaptive halting policy is integrated into the model such that it can decide to stop the transformer's layer computations at an intermediate layer for a given input sequence; and wherein the deployment manager, in conjunction with the scheduling controller, skips the remaining layers upon a halt decision and produces the final output from the current state, or, if the model does not halt early, transfers execution of the remaining layers to the GPU to expedite cooperation.

23. The system of claim 15, wherein the CPU comprises a multi-core processor and the deployment manager runs multiple threads or parallel instances of the large language model to handle multiple user queries concurrently, and wherein the scheduling controller for each instance independently applies the adaptive policy and hardware allocation decisions such that different instances may utilize the GPU or the CPU and halt at different processing points as determined by their respective queries, resulting in high throughput with minimal interference because each instance uses only the necessary computation and an appropriate processor for its query.

24. The system of claim 15, wherein, by employing an adaptive computation mechanism in combination with hybrid CPU-GPU execution, the system achieves an improvement in at least one metric selected from the group consisting of inference throughput, average latency per query, and compute cost per query, relative to a baseline system that executes the same large language model to full depth on a GPU for every query without early exiting.
